(19) United States
(12) Patent Application Publication
(10) Pub. No.: US 2014/0240523 A1
(43) Pub. Date: Aug. 28, 2014

(54) INFORMATION DELIVERY BASED ON IMAGE DATA

(71) Applicant: T-MOBILE USA, INC., Bellevue, WA (US)

(72) Inventor: Uday DODLA, Sammamish, WA (US)

(73) Assignee: T-MOBILE USA, INC., Bellevue, WA (US)

(21) Appl. No.: 13/775,046

(22) Filed: Feb. 22, 2013

(51) Int. Cl. G06F 3/00

(52) U.S. Cl. CPC G06F 3/005
USPC 348/207.1

(57) ABSTRACT

Systems, devices and methods described herein provide or possess functionality that enables capturing an image, images associated with video and/or video. The captured image (or captured images associated with video and/or video) may be communicated to a server (e.g., network operator) that compares the captured image to media stored in a database. That media may include images, images associated with video and/or video. Each of the media may have information associated therewith. Such information may include advertisements, uniform resource locators (URLs), company information, promotions, etc. If the server determines that an image stored in the database matches or substantially matches the image received by the server, the server may retrieve the information that is associated with the stored image. The retrieved information may be communicated to a mobile device that captured the image. The retrieved information may then be displayed by the mobile device and/or presented in another manner.

### BACKGROUND

Personal electronics devices such as smartphones may be used globally across a plurality of networks. The spread of accessible data networks has enabled mobile device users to remain connected to their provider networks and thus all of the data and services available via the Internet and other networks. Such devices typically host a variety of applications such as video and audio applications, image capture devices, and location determination systems such as GPS. The personal electronics devices may also have access to location based services such as searching and mapping functions.

Real world data may be collected using any suitable data collection means, such as a camera or microphone. This data may then be processed and combined with computer generated data to create enhanced data. A form of enhanced data may be created by obtaining video images captured with a camera and processed and enhanced with computer-generated graphics or other images. The resulting enhanced data may then be presented to a user through a user interface. It would be advantageous for mobile devices to have access to data that may be used to enhance a user's use of image data captured by such mobile devices.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure.

FIG. 1 illustrates components of a mobile device, according to an exemplary implementation.

FIG. 2 is a diagrammatic representation of an example network for providing enhanced data/information to a mobile device in accordance with an exemplary implementation.

FIG. 3 is a flow diagram illustrating an example process for enhancing images, images obtained from video, and/or video, according to an implementation.

### DETAILED DESCRIPTION

Systems, devices and methods described herein provide or possess functionality that enables capturing an image, images associated with video and/or video. The captured image (or captured images associated with video and/or video) may be communicated to a server (e.g., network operator) that compares the captured image to media stored in a database. That media may include images, images associated with video and/or video. Each of the media may have information associated therewith. Such information may include advertisements, uniform resource locators (URLs), company information, promotions, etc. If the server determines that an image stored in the database matches or substantially matches the image received by the server, the server may retrieve the information that is associated with the stored image. The retrieved information may be communicated to a mobile device that captured the image. The retrieved information may then be displayed on a display of the mobile device and/or presented (e.g., as sound) in another manner.

Mobile device or user device, as used herein and throughout this disclosure, refers to any electronic device capable of wirelessly sending and receiving data. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories).

Mobile devices may communicate with each other and with other elements via a network, for instance, a wireless network, or a wireline network. A network may include broadband wide-area networks such as cellular networks, local-area networks (LAN), Wi-Fi, and personal area networks, such as near-field communication (NFC) networks including BLUETOOTH®. Communication across a network may be packet-based; however, radio and frequency/amplitude modulation networks may enable communication between communication devices using appropriate analog-digital-analog converters and other elements. Communication may be enabled by hardware or mixed hardware and software elements called transceivers. Mobile devices may have more than one transceiver, capable of communicating over different networks. For example, a cellular telephone may include a cellular transceiver for communicating with a cellular base station, a Wi-Fi transceiver for communicating with a Wi-Fi network, and a BLUETOOTH® transceiver for communicating with a BLUETOOTH® device. A Wi-Fi network is accessible via access points such as wireless routers, etc., that communicate with the Wi-Fi transceiver to send and receive data. The Wi-Fi network may further be connected to the internet or other packet-based networks. The bandwidth of a network connection or an access point is a measure of the rate of data transfer, and can be expressed as a quantity of data transferred per unit of time.

A network typically includes a plurality of elements that host logic or intelligence for performing tasks on the network. The logic can be hosted on servers. In modern packet-based wide-area networks, servers may be placed at several logical points on the network. Servers may further be in communication with databases and can enable communication devices to access the contents of a database. Billing servers, application servers, etc. are examples of such servers. A server may include several network elements, including other servers, and can be logically situation anywhere on a service provider's network, such as the back-end of a cellular network. A server hosts or is in communication with a database hosting an account for a user of a mobile device. The user account includes several attributes for a particular user, including a unique identifier of the mobile device(s) owned by the user, relationships with other users, application usage, location, personal settings, business rules, bank accounts, and other information. A server may communicate with other servers on different networks to update a user account.

A location, as used herein and throughout this disclosure, may be any physical location that is served by one or more networks. A mobile device has a location that can be determined via a plurality of methods such as Global Positioning System (GPS), Assisted GPS (A-GPS), cell tower triangulation, RF signatures, etc. A location may be determined using radio-location via signal measurement from base stations/cell towers, using GPS/A-GPS, or using proximity to NFC transceivers. The area of the location may be controlled by the number and range of the NFC transceivers. Determining a location as a function of time enables a measurement of rate of movement, or speed.

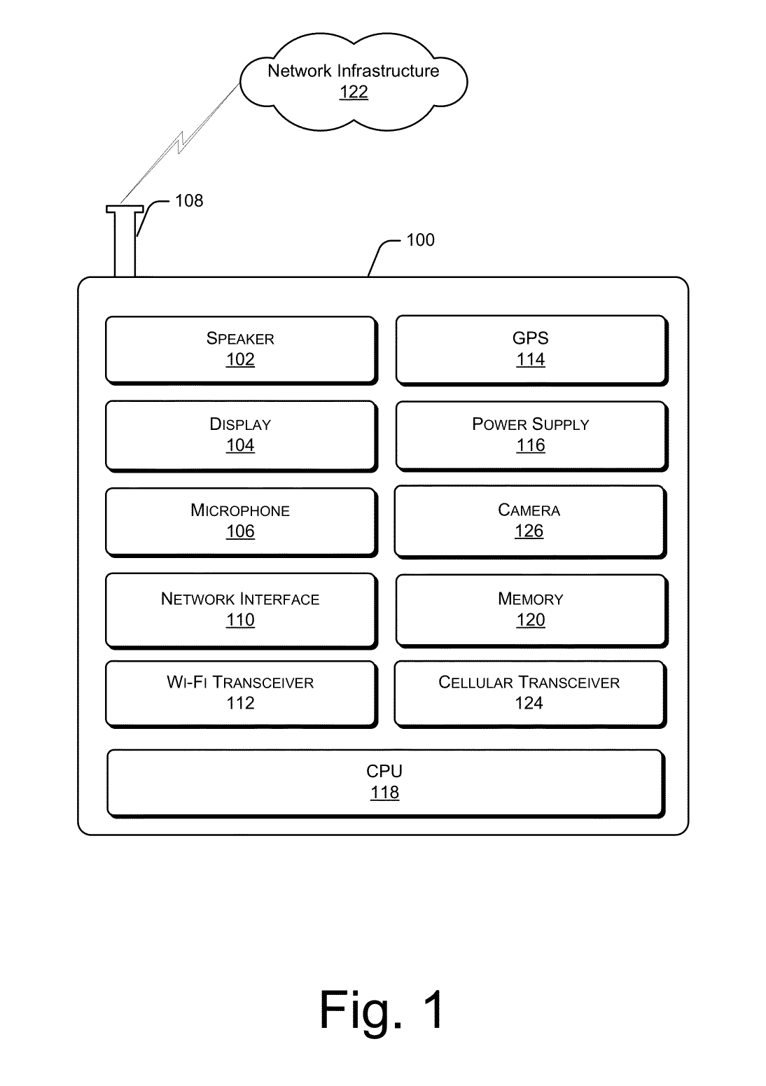

FIG. 1 illustrates components of a mobile device 100, according to an exemplary embodiment. The mobile device 100 may include a speaker 102, a display 104, a microphone 106, and an antenna 108. The mobile device 100 may further include a network interface 110, a Wi-Fi transceiver 112, a Global Positioning System (GPS) receiver 114, a power supply 116, a central processing unit (CPU) 118, and a memory 120. Furthermore, the mobile device 100 may include a cellular transceiver 124 and a camera 126. The camera 126, or what may be referred to as a general image capturing device, may capture images, obtain images from video captured by the camera 126, and capture video.

The speaker 102 provides an audio output for the mobile device 100. The display 104 may be an LCD or LED or other type of display on which a user can view selections, images, video, numbers, letters, etc. The display 104 may also be a touchscreen, thereby being used as an input device. In embodiments not using a touchscreen, a keypad is typically used as an input device, for instance, to type a phone number or a message. Such a keypad may be a numerical keypad, a QWERTY keyboard, etc. The microphone 106 allows the user to verbally communicate with others using mobile device 100. The antenna 108 is a transducer designed to transmit or receive electromagnetic waves to and from a network 122. In conjunction with the antenna 108, the network interface 110 allows mobile device 100 to wirelessly communicate with network 122, such as a cellular network and/or an access point, or with other wireless devices across the network 122. The network 122 may include, but is not limited as such, operator equipment necessary to enable mobile devices to communicate using cellular communication technology and protocols. Furthermore, the network 122 may include servers, servers that include databases, one or more processors that execute instructions stored in memory and/or storage, and the like.

The network interface 110 may be a cellular transceiver, wireless transceiver, etc., and may include combinations of transceivers to communicate with assorted wireless networks. Alternatively, the network interface 110 may couple one or more transceivers of the mobile device 100 to one or more communication networks. The Wi-Fi transceiver 112 enables mobile device 100 to wirelessly communicate over short ranges with a Wi-Fi access point, and through the access point, to a packet-based network such as the Internet, and other devices on the internet. The GPS transceiver 114 enables a determination of a location of mobile device 100, by receiving signals from a GPS satellite. In addition to these signals, network interface 110 can receive assistance data from an A-GPS server on the cellular network, thereby enabling GPS receiver 114 to get a faster fix on a satellite signal. The power supply 116 provides power to each of the components of mobile device 100, and can include a battery, as well as an interface to an external power supply. The CPU 118 controls components of mobile device 100 according to instructions stored in the memory 120.

The memory 120 may be any computer readable medium, such as RAM, ROM, etc. The memory 120 may store intelligence, such as computer readable instructions, in addition to logic for operating the components of mobile device 100. The memory 120 further may store a database or have logically known assessable memory locations including media, such as images, video, files, and the like. The media stored in the memory 120 may have been captured by the camera 126.

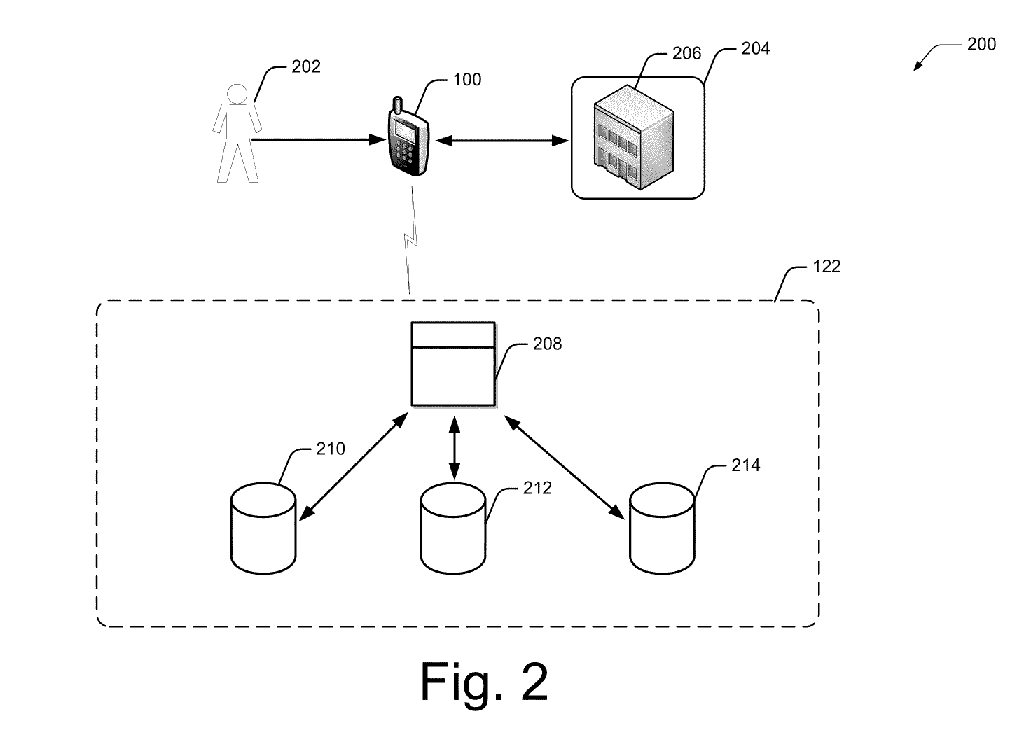

FIG. 2 is a diagrammatic representation of an example network 200 for providing enhanced data/information to the mobile device 100 in accordance with an implementation. As shown, a user 202 may capture an image, an image derived from video, or video using the camera 126 of the mobile device 100. The foregoing will generally be referred to as an image 204, but it is to be understood that the image 204 may be an image, an image derived from video, or video.

The camera 126 may capture the image 204 that includes an object 206. The object 206 may be a scene that includes a plurality of objects, such as a logo(s), a commercial product(s), building(s), and the like. The mobile device 100 may send the image 204 to the network 122. In addition, the mobile device 100 may send metadata associated with the image 204 to the network 122. Such metadata may include location information, obtained by the GPS 114 for example, associated with the image 204.

The network 122 may include a server 208 that hosts a plurality of databases 210, 212 and 214. The server 208 may be configured to perform optical recognition of captured images in order to identify objects in images received by the network 122. The data obtained by the performed optical recognition may be stored in the database 210 that may be used for later object recognition of the same or similar images received by the server 208. The server 208 may parse and analyze the data stored in the database 210 and transfer the parsed and analyzed data to the database 212. Such parsed and analyzed data may be logically stored in the database 212 so that the data is searchable by the server 208. In one implementation, the searchable data in the database 212 includes a plurality of images and/or videos that each has associated information. Such associated information may include promotions, advertisements, an offer to purchase goods or services, information related to a company or companies, uniform resource locators (URLs) associated with the company, URLs linked to products, goods or services, and the like. The database 214 may include user information that the server 208 may use when receiving images sent from user mobile devices, correlating such received images with user information stored in the database 214, and conveying associated information accessible in the database 212 to mobile devices to thereby be disseminated by users. The conveyed associated information may generally be considered to enhance an image or video captured by the mobile device 100, such that the user of the mobile device 100 is provided with information that is related to the image or video captured by the mobile device 100.

Returning, briefly, to the optical recognition that may be performed by the server 208. Such optical recognition may be configured to recognize one or more items within a captured image. Object recognition is the task of finding and recognizing an object(s) in an image or video sequence. For an object in an image, there are may be a plurality of features on the object that can be extracted to provide a feature description of the object. Such feature descriptors extracted from an image can then be used to identify the object when attempting to locate the object in an image containing other objects. An image recognition algorithm may be used to extract feature descriptors and match the extracted features to recognize the image. It may be desirable that such an algorithm be robust to changes in image scale, noise, illumination, local geometric distortion, and orientation/rotation. Feature descriptors may thus generally be defined as a point or part of interest in an image. A feature descriptor may be a distillation of a portion of an image, or an object in an image, to a set of definition data that can be referenced for identification purposes. Generally, a feature descriptor may be associated with recognition. The image areas for objects that may be referenced as the basis of descriptive features may be used for tracking purposes.

A feature descriptor may be part of an object in the field of view that appears in the rendered/captured image. Such a feature descriptor may be used as a point of reference or a measure. Feature descriptors may be also be placed into or on the imaging subject. Feature descriptors may act as reference points, and may further comprise fixed points or lines within an image to which other objects can be related or against which objects can be measured. The recognition of feature descriptors in images may act as a reference for image scaling, or may allow the image and a corresponding physical object to be correlated. By identifying feature descriptors at known locations in an image, the relative scale in the produced image may be determined by comparison of the locations of the markers in the image and subject. A device or system capable of recognizing feature descriptors may perform recognition by examining and processing individual pixels of an image and determining feature properties. Such analysis may further use knowledge databases and applications such as pattern recognition engines. The feature descriptors (e.g., data) obtained from image analysis performed by the server 208 may be stored in the database 210 and then parsed and analyzed and stored in the database 212 in a searchable format for later use by the server 208, as described herein.

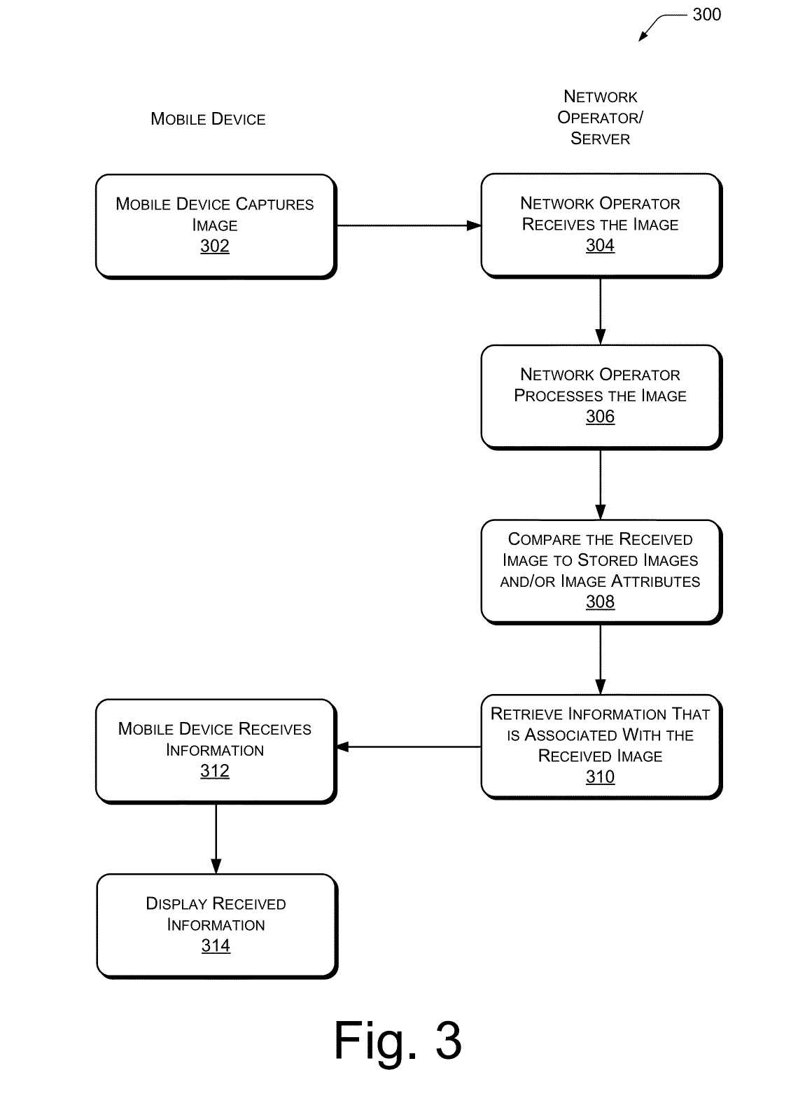

FIG. 3 is a flow diagram illustrating an example process 300 for enhancing images, images obtained from video, and/or video, according to an implementation. The process 300 depicts a process for enhancing images, images obtained from video, and/or video. The process 300 may reference elements illustrated in FIGS. 1-2. However, generally, the disclosed process 300 may be implemented by a device, a system of devices, computer-readable medium including computer-executable instructions that, when executed, perform the process 300, and the like. The process 300 may be executed by a mobile device and a network operator, as is illustrated. However, a mobile device or server may execute the process 300 individually.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable materials, or combinations thereof, without departing from the scope of the subject matter described herein.

At act 302, a mobile device (e.g., the mobile device 100) captures an image, an image derived from video or video (referred to as image). The image may include a scene that includes a plurality of objects, such as a logo(s), a commercial product(s), building(s), and the like. It should be understood that the captured image may alternatively be stored in the mobile device or provided to the mobile device from another source. The mobile device communicates the image to a network operator that includes a server (e.g., the server 208). At act 304, the network operator receives the image. Furthermore, at act 304, the network operator may also receive metadata associated with the image. Such metadata may include location information, obtained by a GPS (e.g., the GPS 114) for example, associated with the image.

At act 306, the network operator processes the image. Processing the image may include analyzing the image using optical recognition to identify objects in the image received by the network operator. Furthermore, the processing of the image may include storing the identified objects and received metadata in a database (e.g., the database 210). The network operator may further parse and analyze the stored data and transfer the parsed and analyzed data to another database (e.g., the database 212). The data transferred to the another database may be searchable, and the data transferred may be associated with information that includes promotions, advertisements, an offer to purchase goods or services, information related to a company or companies, uniform resource locators (URLs) associated with the company, URLs linked to products, goods or services, and the like. More generally, the image data parsed and analyzed, to include the captured image received by the network operator, may be stored in the other database and associated with some or all of such described information.

At act 308, the network operator compares the received image against images stored in the other database. Comparing the received image may involve using image attributes obtained from analyzing the image using optical recognition to identify objects in the image, and the like.

At act 310, the network operator retrieves from the other database information that is associated with the captured image received by the network operator, and delivers the information to the mobile device. If information is not found in the other database, a message may be transmitted to the mobile device that indicates that information for enhancing or augmenting the captured image is not available. In one implementation, the network operator may refer to yet another database (e.g., the database 214) to gather information pertaining to the account holder of the mobile device. Such information may include geographical information, demographic information, personal information, and the like, that may be used by the network operator to refine the types of information retrieved from the other database. For example, user information in the yet another database may indicate that the account holder of the mobile device that captured the image received by the network operator is a university student. The network operator may selectively retrieve, at act 310, information associated with the captured image that may be particularly relevant to university students (e.g., promotions, advertisements, etc.).

At act 312, the mobile device receives the information associated with the image captured in act 302. At act 314, the mobile device displays (e.g., by way of the display 104) some or all of the received information. For example, at act 314, the mobile device may display a promotion, company information, recommendation, advertisement, webpage, and the like, that is related to the image captured in act 302.

In a particular example according to the implementations described herein, the server 208 may receive an image or video captured by the mobile device 100. The image or video may show at least a document that comprises text in a first language format (e.g., Korean). The server 208 may execute stored computer instructions that translate the text in the first language format to text in a second language format (e.g., English). The server 208 may implement optical character recognition (OCR) intelligence as part of the translation process. The server 208 may communicate the English translation to the mobile device 100, which displays or otherwise disseminates (e.g., via audio) the English translation.

In another example according to the implementations described herein, the server 208 may receive an image or video captured by the mobile device 100. The image or video may show a plurality of inanimate objects. For example, the plurality of inanimate objects may be associated with a board game, such as chess. The server 208 may access the database 212 and compare the image or video showing the plurality of inanimate objects against stored, and searchable, images and video and associated information. An image or video match may be found that includes computer executable instructions that enable the sever 208 or the mobile device 100 to render the image or video showing the plurality of inanimate objects as a computer graphical representation or animated version thereof. The mobile device 100 may display the computer graphical representation or animated version of the plurality of inanimate objects. In one particular implementation, the computer executable instructions enable the sever 208 or the mobile device 100 to render the image or video showing the plurality of inanimate objects as an interactive computer graphical representation or interactive animated version of the plurality of inanimate objects. Therefore, in the case of a captured image or video of a board game, the interactive computer graphical representation or interactive animated version of the plurality of inanimate objects associated with the board game provides a computer generated game of the captured image or video of the board game. Such a computer generated game would, when displayed on the mobile device 100, enable user interaction therewith.

In the above description of exemplary implementations, for purposes of explanation, specific numbers, materials configurations, and other details are set forth in order to better explain the invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The exemplary processes discussed herein may be implemented with hardware, software, firmware, or any combination thereof. In the context of software/firmware, instructions stored on one or more processor-readable storage media that, when executed by one or more processors, may perform the recited operations. The operations of the exemplary processes may be rendered in virtually any programming language or environment including (by way of example and not limitation): C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

Processor-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

What is claimed:

1. A system for accessing information, comprising:
a processor; and
a storage including instructions that, when executed by the processor, cause the processor to:
analyze at least an image captured on a mobile device;
retrieve information associated with the image captured on the mobile device; and
deliver, to the mobile device, the retrieved information.

2. The system according to claim 1, wherein the information retrieved is commercial product information related to a commercial product identified in the image captured by the mobile device.

3. The system according to claim 1, wherein the information retrieved is logo associated information related to a logo identified in the image captured by the mobile device.

4. The system according to claim 3, wherein the logo is associated with a company and the logo associated information is at least one of an advertisement, an offer to purchase goods or services, information related to the company, or a uniform resource locator (URL) associated with the company.

5. The system according to claim 1, wherein the information retrieved is at least one of a recommendation, a review, a promotion, an advertisement, a price, an online vendor, or a brick and mortar vendor related to a commercial product identified in the image captured by the mobile device.

6. The system according to claim 1, wherein analyzing the image includes identifying image attributes of the image and comparing the identified image attributes against one or more image attributes stored in the storage, and retrieving the information associated with the image includes retrieving information that is linked to at least one image attribute of the one or more image attributes stored in the storage.

7. The system according to claim 1, wherein the mobile device is at least one of a smartphone, a hand-held device, a camera, or a tablet computer.

8. A system, comprising:
a processor; and
a storage including instructions that, when executed by the processor, cause the processor to:
deliver at least an image captured on a mobile device;
receive information associated with the image captured on the mobile device; and
display the received information.

9. The system according to claim 8, wherein the information received is commercial product information related to a commercial product identified in the image captured by the mobile device.

10. The system according to claim 8, wherein the information received is logo associated information related to a logo identified in the image captured by the mobile device.

11. The system according to claim 10, wherein the logo is associated with a company and the logo associated information is at least one of an advertisement, an offer to purchase goods or services, information related to the company, or a uniform resource locator (URL) associated with the company.

12. The system according to claim 8, wherein the information received is at least one of a recommendation, a review, a promotion, an advertisement, a price, an online vendor, or a brick and mortar vendor related to a commercial product identified in the image captured by the mobile device.

13. The system according to claim 1, wherein the received information associated with the image includes receiving information that is linked to at least one image attribute of one or more stored image attributes.

14. The system according to claim 8, wherein the mobile device is at least one of a smartphone, a hand-held device, a camera, or a tablet computer.

15. A computer-readable medium storing computer-executable instructions that, when executed, perform a method, comprising:
analyzing at least an image that is digitized by an image capturing device;
retrieving information associated with the image that is digitized by the image capturing device; and
deliver, to a mobile device, the retrieved information.

16. The computer-readable medium according to claim 15, wherein the mobile device and the image capturing device are a single device.

17. The computer-readable medium according to claim 15, wherein analyzing the image includes identifying image attributes of the image and comparing the identified image attributes against one or more image attributes stored in the storage, and retrieving the information associated with the image includes retrieving information that is linked to at least one image attribute of the one or more image attributes stored in the storage.

18. The computer-readable medium according to claim 15, wherein the information received is at least one of a recommendation, a review, a promotion, an advertisement, a price, an online vendor, or a brick and mortar vendor related to a commercial product identified in the image captured by the mobile device.

19. The computer-readable medium according to claim 15, further comprising maintaining a database of a plurality of images and information that is associated with each of the plurality of images.

20. The computer-readable medium according to claim 19, wherein the retrieving includes retrieving the information associated with the image from the database.

21. The computer-readable medium according to claim 19, wherein each of the plurality of images in the database has associated therewith at least partially unique information.

22. The computer-readable medium according to claim 21, wherein each of the partially unique information includes at least one of a recommendation, a review, a promotion, an advertisement, a price, an online vendor, or a brick and mortar vendor.
